(19) United States
(12) Patent Application Publication
(10) Pub. No.: US 2013/0260632 A1
(43) Pub. Date: Oct. 3, 2013

(54) FILMS AND FILM LAMINATES WITH RELATIVELY HIGH MACHINE DIRECTION MODULUS

(71) Applicants: Oomman P. Thomas, Alpharetta, GA (US); James L. Austin, Alpharetta, GA (US); Jose Augusto Vidal de Siqueira, Roswell, GA (US)

(72) Inventors: Oomman P. Thomas, Alpharetta, GA (US); James L. Austin, Alpharetta, GA (US); Jose Augusto Vidal de Siqueira, Roswell, GA (US)

(21) Appl. No.: 13/603,809

(22) Filed: Sep. 5, 2012

Related U.S. Application Data
(63) Continuation-in-part of application No. 12/215,870, filed on Jun. 30, 2008, now abandoned.

(51) Int. Cl. C08L 25/06; C08L 53/02

(52) U.S. Cl. CPC C08L 25/06; C08L 53/02
USPC 442/398; 525/95

(57) ABSTRACT

Films and film laminates include a blend of polymers, the blend including an elastomeric block copolymer in an amount from about 51% to about 95% by weight of the blend; and a polystyrenic polymer in an amount from about 1% to about 25% of the weight of the blend, wherein the polystyrenic polymer is selected from the group consisting of polystyrenic homopolymers and polystyrenic random interpolymers. The films and laminates are elastic in the cross machine direction and have a relatively high modulus, or stiffness, in the machine-direction.

### CLAIM OF BENEFIT OF PRIORITY

The present application is a continuation-in-part and claims benefit of priority to U.S. patent application Ser. No. 12/215,870 filed on Jun. 30, 2008, the contents of which are incorporated herein.

### BACKGROUND OF THE INVENTION

Many personal care products contain extensible components in such areas as leg gaskets, waistbands, and side panels. These extensible components provide a variety of functionalities including one-size-fits-all capability, conformance of the product on the user, sustained fit over time, leakage protection, and improved absorbency, for example.

Films and film laminates with good cross-directional stretch properties are desirable for use as extensible components in personal care products. The cross-direction refers to the direction perpendicular to the direction in which the film is produced, i.e., the direction perpendicular to the machine direction. However, films that are extensible in the cross-direction are often also extensible in the machine-direction. Such films that are extensible in the machine direction may present challenges or difficulties during film processing and personal care product manufacturing.

For example, films or components that are extensible in the machine direction may extend excessively in the machine direction during unwinding and cutting of the component film prior to placing the component film in a personal care product. Further, any MD elasticity in the component may cause the component to extend and then snap back or retract during processing, causing disruption to the manufacturing process and excessive waste of defective product.

Thus, there is a need for films that are readily extensible in the cross-direction but are less extensible in the machine direction during film processing and manufacture of personal care products.

### SUMMARY OF THE INVENTION

The problems described above are addressed by films and film laminates that include a blend of polymers including an elastomeric block copolymer containing a styrene block portion having a number average molecular weight or at least about 5,000 Daltons with the elastomeric block copolymer being present in an amount from about 51% to about 95% by weight of the blend. The blend also includes a polystyrenic polymer having a number average molecular weight of at least about 5000 Daltons with the polystrenic polymer being present in an amount from about 1% to about 25% by weight of the blend. The number average molecular weight of the polystyrenic polymer is at least about 10 percent greater than the number average molecular weight of the styrene block portion of the elastomeric block copolymer, with the polystyrenic polymer being selected from the group consisting of polystyrenic homopolymers and polystyrenic random interpolymers.

The films of this invention have good cross-directional stretch properties and have relatively high machine-direction modulus, or stiffness. These properties, particularly the machine direction modulus, allow for ease of applying the films or laminates thereof to personal care products, for example a diaper, with reduced disruption caused by undesirably machine direction extension or elongation of the component.

An increase in the machine direction modulus or stiffness is desired with respect to the present invention and is achieved by adding a polystyrenic polymer whose number average molecular weight is higher than the number average molecular weight of the styrene block of the elastomeric block copolymer. When the number average molecular weight of the polystyrenic polymer is comparable or less than the number average molecular weight of the styrene block of the elastomeric block copolymer, the polystyrenic polymer will associate with the styrene block and phase mix which will not result in a composite with increased modulus. Such is the case, for example, when the styrene block contains styrene-like rings in which case the polystyrenic polymer and the styrene block portion of the elastomeric block copolymer will partially or fully, phase mix. See for example, U.S. Pat. No. 6,187,425 to Bell et al. which is incorporated herein in its entirety by reference thereto for all purposes. However, it was unexpectedly discovered that if the number average molecular weight (Mn) of the polystyrenic polymer is higher than the number average molecular weight of the styrene block of the elastomeric block copolymer (generally, when the number average molecular weight of the polstyrenic polymer is at least 10% greater than the styrene block portion of the elastomeric block copolymer), the polystyrene phases of the two components will segregate thereby causing orientation of the polystryrene along the machine/casting direction of the film and increasing the machine direction modulus or stiffness of the resultant film.

In one embodiment, the film may have a percent elongation at 500 psi, determined as defined herein below, from about 1 to about 80% in a machine direction. In another embodiment, the film has a percent elongation at 500 psi from about 100% to about 500% in a CD direction.

In one embodiment, suitably the elastomeric block copolymer is a styrenic block copolymer. The polystyrenic polymer may suitably be selected from the group consisting of polymers of styrene including general purpose styrene, alkyl ring-substituted styrenes, aryl ring-substituted styrenes, polystyrenic monomers, phenyl maleimide, and combinations thereof. In one embodiment the polystyrenic polymer includes polystyrene.

In one embodiment, the film can be stretched by at least about 100% in the cross-direction. In another embodiment, the film can retract at least 50% after being stretched to 100% in the cross-direction. In a further embodiment, the film exhibits a ratio of percent elongation at 500 psi in the cross machine direction to percent elongation at 500 psi in the machine direction of about 5 to about 50.

In another embodiment a film laminate is formed from a film comprising a blend of polymers with the blend comprising an elastomeric block copolymer containing a styrene block portion having a number average molecular weight or at least about 5,000 Daltons. The elastomeric block copolymer is present in an amount from about 51% to about 95% by weight of the blend. The blend also includes a polystyrenic polymer having a number average molecular weight of at least about 5000 Daltons with the polystrenic polymer being present in an amount from about 1% to about 25% by weight of the blend. The number average molecular weight of the polystyrenic polymer is at least about 10 percent greater than the number average molecular weight of the styrene block portion of the elastomeric block copolymer and the polystyrenic polymer is selected from the group consisting of polystyrenic homopolymers and polystyrenic random interpolymers. Once the film is formed, a nonwoven material attached to the film formed from the foregoing blend.

The film laminate can be stretched by at least about 100% in a cross-direction. In another embodiment, the film laminate can have a percent elongation at 500 psi from about 1 to about 80% in a machine direction. The film laminate can have a percent elongation at 500 psi from about 100% to about 500% in a CD direction. The film laminate can retract at least 50% when stretched to 100% in the cross-direction. The film laminate can exhibit a ratio of percent elongation at 500 psi in the cross machine direction to percent elongation at 500 psi in the machine direction of about 5 to about 50.

The film laminate can have an elastomeric block copolymer which is a styrenic block copolymer. The film laminate can have a polystyrenic polymer which is polystyrene. The polystyrenic polymer can be selected from the group consisting of polymers of styrene, alkyl ring-substituted styrenes, aryl ring-substituted styrenes, polystyrenic monomers, phenyl maleimide, and combinations thereof.

In one aspect, a method of producing a film having a relatively high modulus in a machine direction includes the steps of blending an elastomeric block copolymer and a polystyrenic polymer selected from the group consisting of polystyrenic homopolymers and polystyrenic random interpolymers to form a blend, wherein the blend includes the elastomeric block copolymer in an amount from about 51% to about 95% by weight of the blend and the polystyrenic polymer in an amount from about 1% to about 25% of the weight of the blend with the elastomeric block copolymer containing a styrene block portion having a number average molecular weight or at least about 5,000 Daltons, the polystyrenic polymer having a number average molecular weight of at least about 5000 Daltons, the number average molecular weight of the polystyrenic polymer being at least about 10 percent greater than the number average molecular weight of the styrene block portion of the elastomeric block copolymer, and extruding the blend to form a film. In one embodiment, the method may further include the step of cross-linking the elastomeric block copolymer. In one aspect the polystyrenic polymer may include polystyrene.

In another aspect, the films and laminates described herein are useful and desirable for forming extensible or elastic parts of various disposable personal care and other products.

### BRIEF DESCRIPTION OF THE DRAWINGS

These and other objects and features of this invention will be better understood from the following detailed description taken in conjunction with the drawings, wherein:

FIG. 1 is a stress-elongation curve for a film in accordance with an embodiment of the invention.

FIG. 2 is a stress-elongation curve for a control film.

### DESCRIPTION OF PREFERRED EMBODIMENTS

Reference now will be made in detail to various embodiments of the invention, one or more examples of which are set forth below. Each example is provided by way of explanation, not limitation of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention cover such modifications and variations.

As used herein and in the claims, the term “comprising” is inclusive or open-ended and does not exclude additional unrecited elements, compositional components, or method steps. Accordingly, such term is intended to be synonymous with the words “has”, “have”, “having”, “includes”, “including”, and any derivatives of these words. Additionally, the term “comprising” encompasses the more restrictive terms “consisting essentially of” and “consisting of”.

Unless otherwise indicated, percentages of components in formulations are by weight.

The need defined above is addressed by a film comprising a blend of polymers including from about 51% to about 95% by total weight of the blend of an elastomeric block copolymer which contains a styrene block portion and from about 1% to about 25% by total weight of the blend of a polystyrenic polymer selected from the group consisting of polystyrenic homopolymers and polystyrenic random interpolymers. As used herein, “blend of polymers” refers to a mixture of two or more polymers.

Various elastomeric block copolymers are contemplated for use in the blend of polymers. A “block copolymer” is a polymer in which dissimilar polymer segments, each including a string of similar monomer units, are connected by covalent bonds. For instance, a SBS block copolymer includes a string or segment of repeating styrene units, followed by a string or segment of repeating butadiene units, followed by a second string or segment of repeating styrene units.

In one embodiment, the elastomeric block copolymer includes styrenic block copolymer though other block copolymers may be used provided they yield the requisite increase in film modulus in the machine or casting direction. Also, in the case of non-styrenic block copolymers, by choosing the polymers that are suitable with the block, the requisite increase in modulus can be achieved.

Suitable styrenic block copolymer elastomers include styrene-diene and styrene-olefin block copolymers. Styrene-diene block copolymers include di-block, tri-block, tetra-block and other block copolymers, and may include without limitation styrene-isoprene, styrene-butadiene, styrene-isoprene-styrene, styrene-butadiene-styrene, styrene-isoprene-styrene-isoprene, styrene-isoprene-butadiene-styrene, and styrene-butadiene-styrene-butadiene block copolymers. Styrene-diene polymers which include butadiene (e.g. styrene-butadiene-styrene triblock copolymers) are particularly suitable. One commercially available styrene-butadiene-styrene block copolymer is VECTOR 8508, available from Dexco Polymers L.P. Examples of styrene-isoprene-styrene copolymers include VECTOR 4111A and 4211A, available from Dexco Polymers L.P., and Kraton D1114 and D1160, available from Kraton Polymers LLC. Styrene-diene block copolymers may be particularly advantageous for subsequent crosslinking due to the additional unsaturation.

Styrene-olefin block copolymers include without limitation styrene-diene block copolymers in which the diene groups have been totally or partially selectively hydrogenated, including without limitation styrene-(ethylene-propylene), styrene-(ethylene-butylene), styrene-(ethylene-propylene)-styrene, styrene-(ethylene-butylene)-styrene, styrene-(ethylene-propylene)-styrene-(ethylene-propylene), styrene-(ethylene-ethylene-propylene)-styrene, and styrene-(ethylene-butylene)-styrene-(ethylene-butylene) block copolymers. In the above formulas, the term “styrene” indicates a block sequence of styrene repeating units; the terms “isoprene” and “butadiene” indicate block sequences of diene units; the term “(ethylene-propylene)” indicates a block sequence of ethylene-propylene copolymer units, and the term “(ethylene-butylene)” indicates a block sequence of ethylene-butylene copolymer units.

An increase in the machine direction modulus or stiffness is desired with respect to the present invention and is achieved by adding a polystyrenic polymer whose number average molecular weight is higher than the number average molecular weight of the styrene block of the elastomeric block copolymer. When the number average molecular weight of the polystyrenic polymer is comparable or less than the number average molecular weight of the styrene block of the elastomeric block copolymer, the polystyrenic polymer will associate with the styrene block and phase mix which will not result in a composite with increased modulus. Such is the case, for example, when the styrene block contains styrene-like rings in which case the polystyrenic polymer and the styrene block portion of the elastomeric block copolymer will partially or fully, phase mix. See for example, U.S. Pat. No. 6,187,425 to Bell et al. which is incorporated herein in its entirety by reference thereto for all purposes. However, it was unexpectedly discovered that if the number average molecular weight (Mn) of the polystyrenic polymer is higher than the number average molecular weight of the styrene block of the elastomeric block copolymer (generally, when the number average molecular weight of the polstyrenic polymer is at least 10% greater than the styrene block portion of the elastomeric block copolymer), the polystyrene phases of the two components will segregate thereby causing orientation of the polystryrene along the machine/casting direction of the film and increasing the machine direction modulus or stiffness of the resultant film.

Phase separation of the components within the film composition is necessary to achieve the appropriate properties necessary to increase the modulus of the film in the machine or casting direction while maintaining the elasticity of the film in the cross-machine direction. A discussion regarding phase separation of polymers and the resultant attributes can be found in Ming Jiang, Xiuyun Huang and Tongyin Yu (“Phase separation in polymer blends comprising compolmers: 4. Polycarbonate/polystyrene ABCP system,” Polymer, vol. 26, 1985 which is incorporated herein in its entirety by reference thereto for all purposes.

In the present case, the styrenic block copolymer should have a styrene content of about 10 to about 50% by weight, suitably about 15 to about 25% by weight, and should have an overall number average molecular weight of at least about 15,000 grams/mol, suitably about 30,000 to about 120,000 grams/mol, or about 50,000 to about 80,000 grams/mol. The number average molecular weight of the styrenic block portion in the styrenic block copolymer should be at least above about 5,000 Daltons and typically ranges from about 5,000 to about 17,000 Daltons, preferably from about 7,000 to about 14,000 and the rubber block portion will range from about 50,000 to about 100,000 Daltons and preferably from about 60,000 to about 90,000 Daltons. See, for example, US 2008/0153071A1 which is incorporated herein in its entirety by reference for all purposes. The number average molecular weights of the styrenic block and the rubber block as well as the weight percentage of styrene in the block copolymer are chosen such that the styrene block phase segregates from the rubber block on a molecular level which is important for the polymer to act like an elastomer.

Within the overall composition there are two phase separations that are necessary. The first is a phase separation between the styrene block and the remainder of the elastomeric block copolymer. It is this phase separation that gives the composition the elastic properties needed for end use applications. The second phase separation is between the elastomeric block copolymer and the polystyrenic polymer that is added to the elastomeric block copolymer. Without this segregation or separation of phases between the polystyrenic polymer and the elastomeric block copolymer containing the styrene block portion, the increase in modulus of the film in the machine direction will not take place and without this phase separation, the composite remains elastic in the machine or casting direction thereby making the resultant film more difficult to process in many applications. Whether this phase separation takes place is dependent on both the proportions of the components and the number average molecular weight of the components.

Block copolymers such as polystyrene-polybutadiene-polystyrene or polystyrene-polyisoprene-polystyrene exhibit elastic properties because of the phase segregation or separation of the polystyrene block form the polybutadiene or polyisoprene blocks which can be seen when a thin cross sections of a film cast from the polymer that is stained with osmium tetroxide and observed under a transmission electron microscope (TEM). In the case of the styrenic-block copolymer, because the incomparability of the blocks, at least a two-phase morphology is obtained containing polystyrene hard block domains dispersed in a continuous matrix of the polybutadiene or polyisoprene rubber blocks. In the case of addition of additives that associate with the hard blocks, the TEM would show an increase in the size of the polystyrene domain and therefore the number density of the domains stays the same. However, if the additive forms its own domains, the size of the original domain of the styrenic block copolymer will remain the same but the overall number density of the domains per unit area/volume will increase.

Alternatively or additionally, the elastomeric block copolymer may include an olefin elastomer, for example, single-site catalyzed polyolefins, semi-crystalline polyolefin plastomers, propylene-ethylene copolymers, and so forth. Suitable olefin elastomers include semi-crystalline polyolefin plastomers available under the trade name VISTAMAXX from Exxon-Mobil Chemical Co. Other suitable olefin elastomers include propylene-ethylene copolymers available under the trade name VERSIFY from The Dow Chemical Company.

In another embodiment, the elastomeric block copolymer is a cross-linked elastomeric block copolymer. For example, the elastomeric block copolymer may be a cross-linked styrene-diene block copolymer, a cross-linked styrene-isoprene block copolymer, and so forth.

The elastomeric block copolymer suitably is present in the film in an amount ranging from about 51% to about 95% by weight of the film. In some embodiments the elastomeric block copolymer may be present in the film in an amount ranging from about 60% to about 90% by weight of the film, or ranging from about 70% to about 85% by weight of the film. In other embodiments, the elastomeric block copolymer suitably is present in the film in an amount ranging from about 51% to about 90% by weight of the film, or ranging from about 51% to about 85% by weight of the film, or ranging from about 51% to about 80% by weight of the film. In further embodiments, the elastomeric block copolymer suitably is present in the film in an amount ranging from about 51% to about 95% by weight of the film, or ranging from about 60% to about 95% by weight of the film, or ranging from about 70% to about 95% by weight of the film.

Various polystyrenic polymers are contemplated for use in this invention. Polystyrenic polymers may include styrene homopolymers, including styrene homopolymer analogs and homologs such as alpha-methylstyrene and ring-substituted styrenes and styrene random interpolymers and copolymers. Generally, the polystyrenic polymers will have a number average molecular weight of at least about 5,000 Daltons and can range much higher as indicated below. Furthermore, the number average molecular weight of the polystyrenic polymer will have a number average molecular weight which is at least about ten percent greater than the number average molecular weight of the styrenic block portion of the elastomeric block copolymer.

In one embodiment, the film includes a polystyrenic polymer selected from polymers of styrene, alpha-methyl styrene, 4-methoxy styrene, t-butyl styrene, or chlorostyrene. Polymers of styrene are desirable. Suitable polystyrenic polymers include film grade polystyrenes, general purpose polystyrenes, and high impact polystyrenes, such as are available commercially from numerous suppliers including Nova Chemicals, Shell Chemical Company, Americas Styrenics, LLC, Atofina, Kraton Polymers, and Samsung. For example, STYRON 666D is a suitable general purpose polystyrene resin available from Americas Styerenics LLC. The number average molecular weight (Mn) of polystyrenes including general purpose polystyrene range from about 10,000 to about 100,000 Daltons but the preferred number average molecular weight ranges from about 20,000 to about 90,000 Daltons. Similarly the weight average molecular weight (Mw) for polystyrenes including general purpose polystyrene ranges from about 50,000 to about 250,000 Daltons and preferably from about 60,000 to about 230,000 Daltons.

The film may include polystyrenic polymer in an amount ranging from about 1% to about 25% by weight of the film, or from about 1% to about 17% by weight of the film, or from about 1% to about 15% by weight of the film, or from about 1% to about 12% by weight of the film. In other embodiments, the film may include polystyrenic polymer in an amount ranging from about 5% to about 20% by weight of the film, or from about 5% to about 17% by weight, or from about 5% to about 12% by weight percent of the film.

Besides polymers, the film of the present invention may also contain other components as is known in the art. In one embodiment, for example, the film contains a filler. Fillers are particulates or other forms of material that may be added to the film polymer extrusion blend and that will not chemically interfere with the extruded film, but which may be uniformly dispersed throughout the film. Fillers may serve a variety of purposes, including enhancing film opacity and/or pore formation. For instance, filled films may be made breathable by stretching, which causes the polymer to break away from the filler and create microporous passageways. Breathable microporous elastic films are described, for example, in U.S. Pat. Nos. 5,997,981; 6,015,764; and 6,111,163 to McCormack, et al.; 5,932,497 to Morman, et al.; 6,461,457 to Taylor, et al., which are incorporated herein in their entirety by reference thereto for all purposes.

The fillers suitable for pore formation may have a spherical or non-spherical shape with average particle sizes in the range of from about 0.1 to about 10 microns. Examples of suitable fillers include, but are not limited to, calcium carbonate, various kinds of clay, silica, alumina, barium carbonate, sodium carbonate, magnesium carbonate, talc, barium sulfate, magnesium sulfate, aluminum sulfate, titanium dioxide, zeolites, cellulose-type powders, kaolin, mica, carbon, calcium oxide, magnesium oxide, aluminum hydroxide, pulp powder, wood powder, cellulose derivatives, chitin and chitin derivatives. A suitable coating, such as stearic acid, may also be applied to the filler particles if desired.

Other additives may also be incorporated into the film, such as crosslinking catalysts, radiation cross-linking promoter (pro-rad) additives, melt stabilizers, processing stabilizers, heat stabilizers, light stabilizers, antioxidants, heat aging stabilizers, whitening agents, antiblocking agents, bonding agents, tackifiers, viscosity modifiers, colorants, etc. Generally, it is desirable that the additives have a number average molecular weight of less than 5,000 Daltons. Further, oil components which are liquid at room temperature are not desirable as they can bloom to the surface and cause lamination and delamination issues. Suitable crosslinking catalysts, for instance, may include organic bases, carboxylic acids, and organometallic compounds, such as organic titanates and complexes or carboxylates of lead, cobalt, iron, nickel, zinc and tin (e.g., dibutyltindilaurate, dioctyltinmaleate, dibutyltindiacetate, dibutyltindioctoate, stannous acetate, stannous octoate, lead naphthenate, zinc caprylate, cobalt naphthenate; etc.). Suitable pro-rad additives may likewise include azo compounds, organic peroxides and polyfunctional vinyl or allyl compounds such as, triallyl cyanurate, triallyl isocyanurate, pentaerthritol tetramethacrylate, glutaraldehyde, polyester acrylate oligomers (e.g., available from Sartomer under the designation CN2303), ethylene glycol dimethacrylate, diallyl maleate, dipropargyl maleate, dipropargyl monoallyl cyanurate, dicumyl peroxide, di-tert-butyl peroxide, t-butyl perbenzoate, benzoyl peroxide, cumene hydroperoxide, t-butyl peroctoate, methyl ethyl ketone peroxide, 2,5-dimethyl-2,5-di(t-butyl peroxy)hexane, lauryl peroxide, tert-butyl peracetate, azobisisobutyl nitrite, etc.

Examples of suitable tackifiers may include, for instance, hydrogenated hydrocarbon resins. Generally, it is desirable that the tackifier have a number average molecular weight of less than 5,000 Daltons. REGALREZ™ hydrocarbon resins are examples of such hydrogenated hydrocarbon resins, and are available from Eastman Chemical as are PICCOLASTIC™ D-125 and PICCOLASTIC™ A-75. PICCOLASTIC™ D-125 tackifier has a number average molecular weight of 1300 and the A-75 version has a number average molecular weight of 700.

Other tackifiers are available from ExxonMobil under the ESCOREZ™ designation. Viscosity modifiers may also be employed, such as polyethylene wax (e.g., EPOLENE™ C-10 from Eastman Chemical). Phosphite stabilizers (e.g., IRGAFOS available from Ciba Specialty Chemicals of Terrytown, N.Y. and DOVERPHOS available from Dover Chemical Corp. of Dover, Ohio) are exemplary melt stabilizers. In addition, hindered amine stabilizers (e.g., CHIMASSORB available from Ciba Specialty Chemicals) are exemplary heat and light stabilizers. Further, hindered phenols are commonly used as an antioxidant in the production of films. Some suitable hindered phenols include those available from Ciba Specialty Chemicals of under the trade name “Irganox®”, such as Irganox® 1076, 1010, or E 201. Moreover, bonding agents may also be added to the film to facilitate bonding to additional materials (e.g., nonwoven web). When employed, such additives (e.g., filler, tackifier, antioxidant, stabilizer, crosslinking agents, pro-rad additives, etc.) may each be present in an amount from about 0.001 wt. % to about 25 wt. %, in some embodiments, from about 0.005 wt. % to about 20 wt. %, and in some embodiments, from 0.01 wt. % to about 15 wt. % of the film.

The film desirably has a relatively high modulus, or stiffness, in the machine-direction (MD). Further, the film desirably is extensible in the cross-direction. More desirably, the film may be elastic in the cross-direction. As used herein, the term “extensible” means elongatable or stretchable in at least one direction, but not necessarily recoverable. The term “elastic” refers to a fiber, film or sheet material which upon application of a biasing force, is stretchable by at least 50% to a stretched, biased length which is at least 50% greater than, its relaxed, unstretched length, and which will recover at least 50 percent of its elongation upon release of the stretching, biasing force. “Recover” or “recoverable” refers to a relaxation of a stretched material upon removal of a biasing force following stretching of the material by application of the biasing force. For example, if a material having a relaxed, unbiased length of one (1) inch was elongated 50 percent by stretching to a length of one and one half (1.5) inches the material would have a stretched length that is 50% greater than its relaxed length. If this exemplary stretched material contracted, that is recovered to a length of one and one tenth (1.1) inches after release of the biasing and stretching force, the material would have recovered 80 percent (0.4 inch) of its elongation.

In one embodiment, the film is extensible in the cross-direction. Desirably, the film can be stretched by at least 50% in the cross machine direction without breaking. In some embodiments the film can be stretched in the cross machine direction by at least about 100%, or at least by about 200%, or at least by about 300%, or at least by about 400%, or even more without breaking.

In another embodiment the film is elastic, i.e., the film can be stretched by at least about 100% in the cross-direction, and retracts at least about 50% upon releasing of the stretching force. Desirably, the film can be stretched by at least about 200% in the cross-direction, and retracts at least about 50% upon releasing of the stretching force. Even more desirably, the film can be stretched by at least about 300% in the cross-direction, and retracts at least about 50% upon releasing of the stretching force.

In other embodiments, the film can be stretched by at least about 100% in the cross-direction, and retracts at least about 75% upon releasing of the stretching force. Desirably, the film can be stretched by at least about 200% in the cross-direction, and retracts at least about 75% upon releasing of the stretching force. Even more desirably, the film can be stretched by at least about 300% in the cross-direction, and retracts at least about 75% upon releasing of the stretching force.

The film, while extensible in the cross-direction, has a relatively high modulus, or stiffness, in the machine direction. In one embodiment, the film is stable in a machine-direction. As used herein, “stable” describes a film that supports a stress of at least about 500 psi at a percent elongation less than about 100% (percent elongation at 500 psi, measured as defined in the test described herein below). In one embodiment, the film exhibits a percent elongation at 500 psi ranging from about 1% to about 80%. More desirably, the film may exhibit a percent elongation at 500 psi in the machine direction ranging from about 1% to about 50%, or from about 1% to about 20%. In the cross machine direction, the film may exhibit a percent elongation at 500 psi ranging from about 100% to about 500%. In other embodiments, the film may have a percent elongation at 500 psi in the cross machine direction ranging from about 150% to about 450%, or from about 200% to about 400%.

Desirably, the film exhibits a high ratio of the percent elongation at 500 psi in the cross machine direction to the percent elongation at 500 psi in the machine direction. In some embodiments, the ratio of the percent elongations at 500 psi (CD:MD) may range from about 5 to about 50. In other embodiments, the ratio may range from about 10 to about 45, or from about 15 to about 40, or from 15 to about 35, or from about 20 to about 30.

It has been found that the film of this invention allows for improved processing functionality, particularly in forming personal care products such as diapers.

In addition to forming a three-dimensional elastomer network, crosslinking may also provide a variety of other benefits. Lotions used to enhance skin care, for instance, may contain petroleum-based components and/or other components that are compatible with thermoplastics polymers. If the lotions come into sufficient contact with an elastic material, its performance may be significantly degraded. In this regard, the crosslinked film may exhibit improvement in lotion degradation resistance.

The film may be formed from any film-making processes known to those skilled in the art, for example, using either a cast or blown film process, or an extrusion coating type of manufacturing process. Following forming of the film, achievement of the cross-directional extensibility and/or elasticity with relatively high modulus, or stiffness, in the machine direction may be enhanced by orienting or stretching the film in the machine direction. Additionally and/or alternatively, achievement of the cross-directional extensibility and/or elasticity with relatively high modulus, or stiffness, in the machine-direction may be enhanced by cross-linking one or more of the polymers in the blend.

The films are desirably extruded from a polymer blend that includes the elastomeric block copolymer and the polystyrenic polymer to form a precursor film. As such, the elastomeric block copolymer suitably is not crosslinked until after it is formed into a film. Crosslinking of the elastomeric block copolymer prior to extrusion may detrimentally impact the material flow properties of the composite blend, thereby rendering the elastomeric block copolymer unsuitable for extrusion. The molecular weight of the elastomeric block copolymer or polymer blend should be low enough that the blend can be formed into a film without inducing significant crosslinking during film formation. The elastomeric block copolymer or polymer mixture should be suitable for processing at temperatures below about 220° C., suitably below about 210° C., or about 125-200° C. The molecular weight range needed to achieve this objective will vary depending on the type of elastomeric block copolymer, the amount and type of additional ingredients, and the characteristics of the film being formed.

According to one embodiment, the elastomeric block copolymer is a cross-linkable elastomeric block copolymer that is crosslinked after it is incorporated into a precursor film to provide the desired elastic characteristics. Crosslinking may be achieved through the formation of free radicals (unpaired electrons) that link together to form a plurality of carbon-carbon covalent bonds. Free radical formation may be accomplished in a variety of ways, such as through electromagnetic radiation, either alone or in the presence of pro-rad additives, such as described above. More specifically, crosslinking may be induced by subjecting the precursor elastic material to electromagnetic radiation. Some suitable examples of electromagnetic radiation that may be used in the present invention include, but are not limited to, ultraviolet light, electron beam radiation, natural and artificial radio isotopes (e.g., α, β, and γ rays), x-rays, neutron beams, positively-charged beams, laser beams, and so forth. Electron beam radiation, for instance, involves the production of accelerated electrons by an electron beam device. Electron beam devices are generally well known in the art. For instance, in one embodiment, an electron beam device may be used that is available from Energy Sciences, Inc., of Woburn, Mass. under the name “Microbeam LV.” Other examples of suitable electron beam devices are described in U.S. Pat. Nos. 5,003,178 to Livesay; 5,962,995 to Avnery; 6,407,492 to Avnery, et al., which are incorporated herein in their entirety by reference thereto for all purposes.

The actual dosage and/or energy level required depend(s) on the type of polymers and electromagnetic radiation. Specifically, certain types of cross-linkable elastomeric block copolymers may tend to form a lesser or greater number of crosslinks, which will influence the dosage and energy of the radiation utilized. Likewise, certain types of electromagnetic radiation may be less effective in crosslinking the polymer, and thus may be utilized at a higher dosage and/or energy level. For instance, electromagnetic radiation that has a relatively high wavelength (lower frequency) may be less efficient in crosslinking the polymer than electromagnetic radiation having a relatively low wavelength (higher frequency). Accordingly, in such instances, the desired dosage and/or energy level may be increased to achieve the desired degree of crosslinking.

One or more sheet materials may be laminated to the film to form a laminate that may, for example, reduce the coefficient of friction and/or enhance the cloth-like feel of the surface. The sheet materials may include woven materials, nonwoven webs, polymeric films, polymeric scrim-like materials, polymeric foam sheeting, and so forth. The film and the sheet material may be adhered through a bonding step, such as through adhesive bonding, thermal bonding, point bonding, pressure bonding, extrusion coating or ultrasonic bonding. Desirably, the sheet material may include one or more nonwoven webs. The nonwoven web may have a structure of individual fibers or threads which are interlaid, but not in an identifiable manner as in a knitted or woven fabric. Nonwoven fabrics or webs have been formed from many processes such as for example, meltblowing processes, spunbonding processes, and bonded carded web processes.

As one example, the spunbonding process produces a nonwoven web of spunbond fibers. Spunbond fibers generally include small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, and U.S. Pat. No. 3,542,615 to Dobo et al. Spunbond fibers are generally not tacky when they are deposited onto a collecting surface. Spunbond fibers are generally continuous and have average diameters (from a sample of at least 10) larger than 7 microns, more particularly, between about 10 and 20 microns.

As another example, the meltblown process produces a nonwoven web of meltblown fibers. Meltblown fibers generally include fibers formed by extruding a molten thermoplastic material through a plurality of fine, usually circular, die capillaries as molten threads or filaments into converging high velocity, usually hot, gas (e.g., air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly disbursed meltblown fibers. Such a process is disclosed, for example, in U.S. Pat. No. 3,849,241 to Butin et al. Meltblown fibers are microfibers which may be continuous or discontinuous, are generally smaller than 10 microns in average diameter, and are usually tacky when deposited onto a collecting surface.

The basis weight of the nonwoven web facing may generally vary, such as from about 5 grams per square meter (“gsm”) to 120 gsm, in some embodiments from about 8 gsm to about 70 gsm, and in some embodiments, from about 10 gsm to about 35 gsm. When multiple nonwoven web facings are used, such materials may have the same or different basis weights.

Exemplary polymers for use in forming nonwoven web facings may include, for instance, polyolefins, e.g., polyethylene, polypropylene, polybutylene, etc.; polytetrafluoroethylene; polyesters, e.g., polyethylene terephthalate and so forth; polyvinyl acetate; polyvinyl chloride acetate; polyvinyl butyral; acrylic resins, e.g., polyacrylate, polymethylacrylate, polymethylmethacrylate, and so forth; polyamides, e.g., nylon; polyvinyl chloride; polyvinylidene chloride; polystyrene; polyvinyl alcohol; polyurethanes; polylactic acid; copolymers thereof; and so forth. If desired, biodegradable polymers, such as those described above, may also be employed. Synthetic or natural cellulosic polymers may also be used, including but not limited to, cellulosic esters; cellulosic ethers; cellulosic nitrates; cellulosic acetates; cellulosic acetate butyrates; ethyl cellulose; regenerated celluloses, such as viscose, rayon, and so forth. It should be noted that the polymer(s) may also contain other additives, such as processing aids or treatment compositions to impart desired properties to the fibers, residual amounts of solvents, pigments or colorants, and so forth.

Monocomponent and/or multicomponent fibers may be used to form the nonwoven web facing. Monocomponent fibers are generally formed from a polymer or blend of polymers extruded from a single extruder. Multicomponent fibers are generally formed from two or more polymers (e.g., bicomponent fibers) extruded from separate extruders. The polymers may be arranged in substantially constantly positioned distinct zones across the cross-section of the fibers. The components may be arranged in any desired configuration, such as sheath-core, side-by-side, pie, island-in-the-sea, three island, bull's eye, or various other arrangements known in the art. Various methods for forming multicomponent fibers are described in U.S. Pat. No. 4,789,592 to Taniguchi et al. and U.S. Pat. Nos. 5,336,552 to Strack, et al., 5,108,820 to Kaneko, et al., 4,795,668 to Kruege, et al., 5,382,400 to Pike, et al., 5,336,552 to Strack, et al., and 6,200,669 to Marmon, et al., which are incorporated herein in their entirety by reference thereto for all purposes. Multicomponent fibers having various irregular shapes may also be formed, such as described in U.S. Pat. Nos. 5,277,976 to Hogle, et al., 5,162,074 to Hills, 5,466,410 to Hills, 5,069,970 to Largman, et al., and 5,057,368 to Largman, et al., which are incorporated herein in their entirety by reference thereto for all purposes.

If desired, the nonwoven web facing used to form the nonwoven composite may have a multi-layer structure. Suitable multi-layered materials may include, for instance, spunbond/meltblown/spunbond (SMS) laminates and spunbond/meltblown (SM) laminates. Various examples of suitable SMS laminates are described in U.S. Pat. Nos. 4,041,203 to Brock et al.; 5,213,881 to Timmons, et al.; 5,464,688 to Timmons, et al.; 4,374,888 to Bornslaeger; 5,169,706 to Collier, et al.; and 4,766,029 to Brock et al., which are incorporated herein in their entirety by reference thereto for all purposes. In addition, commercially available SMS laminates may be obtained from Kimberly-Clark Corporation under the designations Spunguard® and Evolution®.

A nonwoven web facing may also contain an additional fibrous component such that it is considered a composite. For example, a nonwoven web may be entangled with another fibrous component using any of a variety of entanglement techniques known in the art (e.g., hydraulic, air, mechanical, etc.). In one embodiment, the nonwoven web is integrally entangled with cellulosic fibers using hydraulic entanglement. A typical hydraulic entangling process utilizes high pressure jet streams of water to entangle fibers to form a highly entangled consolidated fibrous structure, e.g., a nonwoven web. Hydraulically entangled nonwoven webs of staple length and continuous fibers are disclosed, for example, in U.S. Pat. Nos. 3,494,821 to Evans and 4,144,370 to Boulton, which are incorporated herein in their entirety by reference thereto for all purposes. Hydraulically entangled composite nonwoven webs of a continuous fiber nonwoven web and a pulp layer are disclosed, for example, in U.S. Patent Nos. 5,284,703 to Everhart, et al. and 6,315,864 to Anderson, et al., which are incorporated herein in their entirety by reference thereto for all purposes.

The nonwoven web facing may be necked in one or more directions prior to lamination to the film of the present invention. Suitable necking techniques are described in U.S. Pat. Nos. 5,336,545, 5,226,992, 4,981,747 and 4,965,122 to Morman, as well as U.S. Patent Application Publication No. 2004/0121687 to Morman, et al. Alternatively, the nonwoven web may remain relatively inextensible in a direction prior to lamination to the film. In such embodiments, the nonwoven web may be optionally stretched in one or more directions, for example the machine or cross machine directions, subsequent to lamination to the elastic material.

Any of a variety of techniques may be employed to laminate the layers together, including adhesive bonding; thermal bonding; ultrasonic bonding; microwave bonding; extrusion coating; and so forth. In one particular embodiment, nip rolls apply a pressure to the precursor elastic material (e.g., film) and nonwoven facing(s) to thermally bond the materials together. The rolls may be smooth and/or contain a plurality of raised bonding elements. Adhesives may also be employed, such as Rextac 2730 and 2723 available from Huntsman Polymers of Houston, Tex., as well as adhesives available from Bostik Findley, Inc, of Wauwatosa, Wis. The type and basis weight of the adhesive used will be determined on the elastic attributes desired in the final composite and end use. For instance, the basis weight of the adhesive may be from about 1.0 to about 3.0 gsm. The adhesive may be applied to the nonwoven web facings and/or the elastic material prior to lamination using any known technique, such as slot or melt spray adhesive systems. During lamination, the elastic material may in a stretched or relaxed condition depending on the desired properties of the resulting composite.

The lamination of the nonwoven web facing(s) and the film may occur before and/or after crosslinking of a cross-linkable elastomeric block copolymer. In one embodiment, for example, a precursor film is initially laminated to a nonwoven web facing, and the resulting composite is subsequently subjected to the step of cross-linking the cross-linkable elastomeric block copolymer as described above.

Various additional potential processing and/or finishing steps known in the art, such as slitting, treating, printing graphics, etc., may be performed without departing from the spirit and scope of the invention. For instance, the film or laminate may optionally be mechanically stretched in the cross-machine and/or machine directions to enhance extensibility, such as by grooved rolls or incremental stretching apparatus. In one embodiment, the film or laminate may be coursed through two or more rolls that have grooves in the CD and/or MD directions. Such grooved satellite/anvil roll arrangements are described in U.S. Patent Application Publication Nos. 2004/0110442 to Rhim, et al. and 2006/0151914 to Gerndt, et al., which are incorporated herein in their entirety by reference thereto for all purposes. The grooved rolls may be constructed of steel or other hard material (such as a hard rubber). If desired, heat may be applied by any suitable method known in the art, such as heated air, infrared heaters, heated nipped rolls, or partial wrapping of the film or laminate around one or more heated rolls or steam canisters, etc. Heat may also be applied to the grooved rolls themselves. It should also be understood that other grooved roll arrangement are equally suitable, such as two grooved rolls positioned immediately adjacent to one another. Besides grooved rolls, other techniques may also be used to mechanically stretch the film or laminate in one or more directions. For example, the film or laminate may be passed through a tenter frame that stretches the composite. Such tenter frames are well known in the art and described, for instance, in U.S. Patent Application Publication No. 2004/0121687 to Morman, et al. The film or laminate may be “stretch bonded” into a stretch bonded laminate. A stretch bonding process is a process wherein an elastic member is bonded to another member while only the elastic member is extended, such as by at least about 25 percent of its relaxed length. A stretch bonded laminate is a composite elastic material made according to the stretch bonding process, i.e., the layers are joined together when only the elastic layer is in an extended condition so that upon relaxing the layers, the nonelastic layer is gathered. The stretch bonded laminate may be subsequently stretched to the extent that the nonelastic material gathered between the bond locations allows the elastic material to elongate. The film or laminate may also be necked or incorporated in a neck bonded laminate. Suitable necking techniques are described in U.S. Pat. Nos. 5,336,545, 5,226,992, 4,981,747 and 4,965,122 to Morman, as well as U.S. Patent Application Publication No. 2004/0121687 to Morman, et al., all of which are incorporated herein in their entirety by reference thereto for all purposes.

The films and/or laminates of the present invention may have a wide variety of applications, but are particularly useful as a component of absorbent personal care articles such as training pants, absorbent underpants, adult incontinence products, feminine hygiene products (e.g., sanitary napkins), swim wear, baby wipes, and so forth. The films and/or laminates may also find use in medical absorbent articles, such as garments (gowns, caps, drapes, gloves, facemasks and so forth), fenestration materials, underpads, bandages, absorbent drapes, and medical wipes; food service wipers; clothing articles; and so forth, and industrial workwear garments, such as laboratory coats, coveralls, and so forth.

Absorbent personal care articles normally include a substantially liquid-impermeable layer (e.g., outer cover), a liquid-permeable layer (e.g., bodyside liner, surge layer, etc.), an absorbent core, and various other optional components. As is well known in the art, a variety of absorbent article components may desirably possess extensible or elastic characteristics, such as waistbands, leg/cuff gasketing, ears, side panels, outer covers (backsheets), and so forth. The extensible films or laminates of the present invention may be employed for use in any of such components. As described above, the films are extensible and/or elastic in the cross-direction while having a relatively high modulus, or stiffness, in the machine direction. Because the films have a relatively high modulus, or stiffness, in the machine direction, the films are more dimensionally stable during attachment to other components of the absorbent article and thus provide greater freedom in the location and manner in which the components are attached together.

The present invention may be better understood with reference to the following examples.

### Test Method Procedures

### Tensile Testing:

The films were tested in both the machine direction (MD) and the cross-machine direction (CD) using a tensile testing procedure to determine stress-elongation behavior. For the MD test, the sample size was 7.6 centimeters in the CD by 17.8 centimeters in the MD. For the CD test, the sample size was 7.6 centimeters in the MD by 17.8 centimeters in the CD. The grip size was 7.6 centimeters width. The grip separation was 10.16 centimeters. The samples were loaded such that the long direction of the sample was the direction along which the samples were stretched. A preload of approximately 10-15 grams was set. The test pulled the sample to break while recording load vs. elongation as a percentage of the initial grip separation distance (10.16 centimeters). Date was recorded every 0.1 seconds. The testing was done on a MTS Corp. constant rate of extension tester 2/S with a Renew MTS mongoose box (controller) using TESTWORKS 4.08 software (MTS Corp, of Eden Prairie Minn.). The tests were conducted under ambient conditions at a crosshead speed of 50.8 centimeters per minute. The load measurements were converted to units of stress by dividing the load by the product of the thickness of the film and the width of the sample. A Mitutoyo caliper model number 547 is used to measure the thickness of six different film samples, which are averaged.

The measure of stiffness (or modulus) of the material was defined as the percent elongation at which a stress of 500 psi was reached during the tensile test (percent elongation at 500 psi). The percent elongation at 500 psi was determined by linearly interpolating between the data points on each side of 500 psi. For example, if the data point immediately before 500 psi was (14%, 410 psi) and the data point immediately after 500 psi was (15%, 520 grams-force), then the percent elongation at 500 psi would be, by linear interpolation, 14+((500-410)(15-14)/(520-410)), or 14.81%.

### EXAMPLES

Polymer dry blends were initially formed according to the formulations shown in Table 1.

TABLE 1
Polymer Dry Blends

| Sample | Formulation (weight percentages) |
|---|---|
| 1 | 80% D1160 SIS, 20% STYRON 666D polystyrene |
| Control | 85% D1160 SIS, 15% Escorene polyethylene |

SIS D1160 is a cross-linkable styrene-isoprene-styrene elastomeric block copolymer available from Kraton Polymers, LLC. STYRON 666D is a general purpose polystyrene polymer available from Americas Styrenics LLC, Escorene is a polyethylene polymer available from ExxonMobil Chemical Company.

Films were formed from each blend according to the following procedure. The blends were introduced into the hopper of a Leistritz twin screw co-rotating multi-mode extruder (Model Mic 27GL/40D) equipped with 27 mm screws at a 40:1 length/diameter (“L/D”). The extruder is an electrical resistance heated extruder with water cooling, and contains 9 barrel heating sections and 2 auxiliary heating sections. The extruder was fitted with two “pineapple” mixing elements based on the principle of distributive mixing in the middle and end zones. The extruder was also directly fitted with a 14″ coat-hanger type film die that can be heated. The extrusion parameters are set forth below in Table 2:

TABLE 2
Example Extrusion Parameters

| Sample | 1 | Control |
|---|---|---|
| Feed Rate (lb/hr) | 8 | 8 |
| Screw Speed (rpms) | 300 | 300 |
| Zone 1 (° C.) | 130 | 130 |
| Zone 2 (° C.) | 175 | 175 |
| Zone 3 (° C.) | 185 | 185 |
| Zone 4 (° C.) | 185 | 185 |
| Zone 5 (° C.) | 185 | 185 |
| Zone 6 (° C.) | 185 | 185 |
| Die (° C.) | 180 | 165 |
| Winder Speed (ft/min) | 32 | 32 |
| Die Pressure (psi) | 230 | 210 |

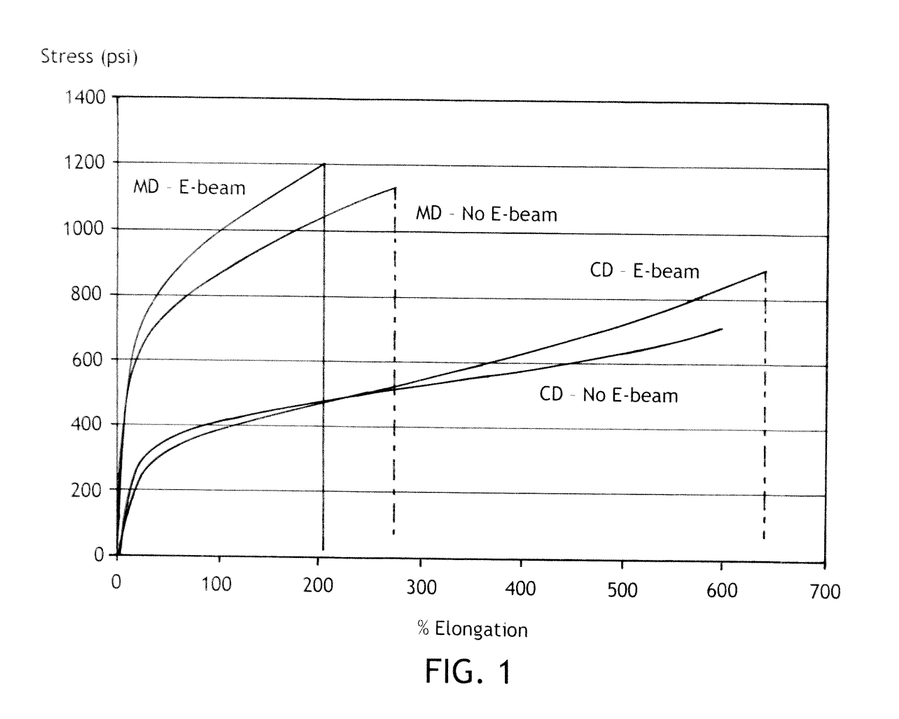

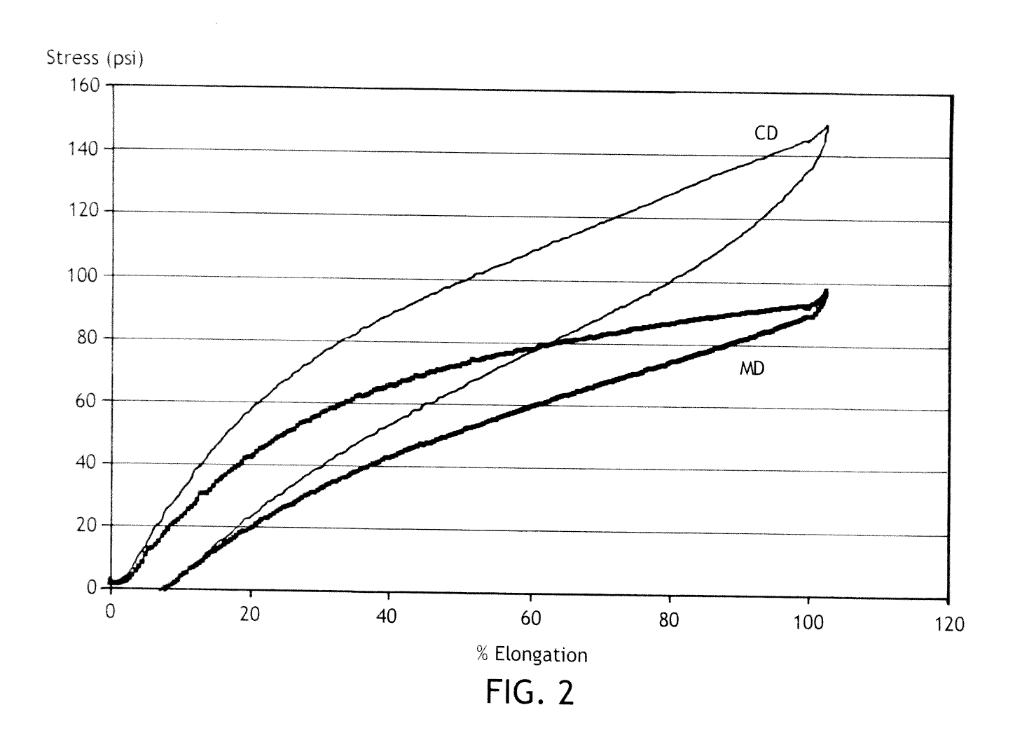

The film was cast onto a chilled roll controlled to a temperature of about 20 deg C. and wound on a carrier sheet. Once formed, portions of the film samples were subjected to electron beam radiation using Energy Sciences' pilot line equipment, which operated at 190 kV, at a depth of 150 microns, density of 1 g/cc, and a dosage range of 10-15 Mrads depending on speed. The samples had an approximate dimension of 10″×11″ and were placed on a carrier film that unwinds at one end and winds in the other end. Exposed samples were collected and run a second or third time depending on the dosage required. The materials were tested for machine direction and cross machine direction tensile properties, including modulus, as described above. Modulus results are shown in Table 3. Tensile test results are shown in FIG. 1 for sample 1 and FIG. 2 for the control sample. FIG. 1 shows results for both an uncross-linked sample (no e-beam) and a cross-linked sample (15Mrad e-beam). The sample shown in FIG. 2 was cross-linked at 10MRad.

The film samples containing the polystyrene had good CD stretch properties and had a higher modulus in the machine-direction than in the cross-direction, for both the uncross-linked and the cross-linked samples. The control sample containing no polystyrene had similar stretch and modulus properties in both directions.

TABLE 3
Modulus

| | CD | MD | CD/MD Ratio of |
|---|---|---|---|
| | Elongation @ | Elongation @ | Elongation @ |
| Sample | 500 psi Stress (%) | 500 psi Stress (%) | 500 psi Stress |
| 1 | 273 | 10 | 27 |
| 1 (x-linked) | 238 | 10 | 24 |
| Control | >100 | >100 | — |

Thus, the invention provides a film that has MD stiffness and CD extensibility, properties useful for providing more efficient processing when incorporating into personal care products, thereby reducing production time and costs.

It will be appreciated that details of the foregoing embodiments, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, yet the absence of a particular advantage shall not be construed to necessarily mean that such an embodiment is outside the scope of the present invention.

What is claimed is:

1. A film comprising a blend of polymers, the blend comprising
An elastomeric block copolymer containing a styrene block portion having a number average molecular weight or at least about 5,000 Daltons, the elastomeric block copolymer being present in an amount from about 51% to about 95% by weight of the blend; and
a polystyrenic polymer having a number average molecular weight of at least about 5000 Daltons, the polystrenic polymer being present in an amount from about 1% to about 25% by weight of the blend, the number average molecular weight of the polystyrenic polymer being at least about 10 percent greater than the number average molecular weight of the styrene block portion of the elastomeric block copolymer, and wherein the polystyrenic polymer is selected from the group consisting of polystyrenic homopolymers and polystyrenic random interpolymers.

2. The film of claim 1, wherein the film has a percent elongation at 500 psi from about 1 to about 80% in a machine direction.

3. The film of claim 1, wherein the film has a percent elongation at 500 psi from about 100% to about 500% in a cross machine direction.

4. The film of claim 1, wherein the elastomeric block copolymer is a styrenic block copolymer.

5. The film of claim 1, wherein the polystyrenic polymer is selected from the group consisting of polymers of styrene, alkyl ring-substituted styrenes, aryl ring-substituted styrenes, polystyrenic monomers, phenyl maleimide, and combinations thereof.

6. The film of claim 1, wherein the polystyrenic polymer is a homopolymer.

7. The film of claim 1, wherein the film can be stretched by at least about 100% in the cross machine direction.

8. The film of claim 1, wherein the film can retract at least 50% after being stretched to 100% in the cross-direction.

9. The film of claim 1, wherein the film exhibits a ratio of percent elongation at 500 psi in the cross machine direction to percent elongation at 500 psi in the machine direction of about 5 to about 50.

10. A film laminate, comprising:
a film comprising a blend of polymers, the blend comprising
an elastomeric block copolymer containing a styrene block portion having a number average molecular weight or at least about 5,000 Daltons, the elastomeric block copolymer being present in an amount from about 51% to about 95% by weight of the blend;
a polystyrenic polymer having a number average molecular weight of at least about 5000 Daltons, the polystrenic polymer being present in an amount from about 1% to about 25% by weight of the blend, the number average molecular weight of the polystyrenic polymer being at least about 10 percent greater than the number average molecular weight of the styrene block portion of the elastomeric block copolymer, and wherein the polystyrenic polymer is selected from the group consisting of polystyrenic homopolymers and polystyrenic random interpolymers; and
a nonwoven material attached to the film.

11. The film laminate of claim 10, wherein the film laminate can be stretched by at least about 100% in a cross machine direction.

12. The film laminate of claim 10, wherein the film laminate has a percent elongation at 500 psi from about 1 to about 80% in a machine direction.

13. The film laminate of claim 10, wherein the film laminate has a percent elongation at 500 psi from about 100% to about 500% in a cross machine direction.

14. The film laminate of claim 10, wherein the elastomeric block copolymer is a styrenic block copolymer.

15. The film laminate of claim 10, wherein the polystyrenic polymer is selected from the group consisting of polymers of styrene, alkyl ring-substituted styrenes, aryl ring-substituted styrenes, polystyrenic monomers, phenyl maleimide, and combinations thereof.

16. The film laminate of claim 10, wherein the polystyrenic polymer is a homopolymer.

17. The film laminate of claim 10, wherein the film laminate can retract at least 50% when stretched to 100% in the cross machine direction.

18. The film laminate of claim 10, wherein the film laminate exhibits a ratio of percent elongation at 500 psi in the cross machine direction to percent elongation at 500 psi in the machine direction of about 5 to about 50.

19. A method of producing a film having a relatively high modulus in a machine direction, the method comprising the steps of:
blending an elastomeric block copolymer and a polystyrenic polymer selected from the group consisting of polystyrenic homopolymers and polystyrenic random interpolymers to form a blend, the blend comprising the elastomeric block copolymer in an amount from about 51% to about 95% by weight of the blend, and the polystyrenic polymer in an amount from about 1% to about 25% by weight of the blend, the elastomeric block copolymer containing a styrene block portion having a number average molecular weight or at least about 5,000 Daltons, the polystyrenic polymer having a number average molecular weight of at least about 5000 Daltons, the number average molecular weight of the polystyrenic polymer being at least about 10 percent greater than the number average molecular weight of the styrene block portion of the elastomeric block copolymer, and
extruding the blend to form a film.

20. The method of claim 19 further comprising the step of cross-linking the elastomeric block copolymer.

21. The method of claim 19, wherein the polystyrenic polymer comprises a homopolymer.

22. A personal care product comprising the film of claim 1.
